(19) United States
(12) Patent Application Publication
(10) Pub. No.: US 2012/0133909 A1
(43) Pub. Date: May 31, 2012

(54) PROJECTION DISPLAY APPARATUS

(75) Inventors: Makoto Maeda, Nara-City (JP); Shinya Matsumoto, Uji-City (JP); Ryuhei Amano, Hirakata-City (JP)

(73) Assignee: SANYO ELECTRIC CO., LTD., Osaka (JP)

(21) Appl. No.: 13/307,635

(22) Filed: Nov. 30, 2011

(30) Foreign Application Priority Data
Nov. 30, 2010 (JP) 2010-267794

(51) Int. Cl. G03B 21/28

(52) U.S. Cl. 353/98

(57) ABSTRACT

A projection display apparatus includes a housing member that houses a light source, an imager that modulates light emitted from the light source, and a projection unit that projects light emitted from the imager onto a projection plane, wherein the projection unit has a concave mirror that reflects the light emitted from the imager to the projection plane side, and the housing member pivotally supports the concave mirror along a circumference of a virtual circle formed by a virtual extension line of the concave mirror.

### CROSS REFERENCE TO RELATED APPLICATIONS

This application is based upon and claims the benefit of priority from prior Japanese Patent Application No. 2010-267794 filed on Nov. 30, 2010; the entire content of which is incorporated herein by reference.

### BACKGROUND OF THE INVENTION

1. Technical Field

The present invention relates to a projection display apparatus including a housing member that houses a light source, an imager that modulates light emitted from the light source and a projection unit that project the light emitted from the imager, onto a projection plane.

2. Background Art

Conventionally, there is known a projection display apparatus including a housing member that houses a light source, an imager that modulates light emitted from the light source, and a projection unit that projects the light emitted from the imager, onto a projection plane.

In recent years, a projection display apparatus has been proposed, in which a concave mirror is arranged in the projection unit in order to reduce a distance between the projection display apparatus and the projection plane.

However, in a case where the light that has emitted from the imager is reflected by the concave mirror, and the light that has emitted from the imager is projected onto the projection plane, a certain distance is necessary between the imager and the concave mirror.

On the other hand, a miniaturization of the projection display apparatus is highly desired. As one of the miniaturized projection display apparatuses, there has been proposed a projection display apparatus in which the concave mirror slides along the optical axis direction of the projection unit (for example, refer to Japanese Unexamined Patent Application Publication No. 2009-86315).

Meanwhile, as the housing member of the projection display apparatus is seen from the side view, the concave mirror is arranged on the opposite side of the imager with respect to the optical axis of the projection unit. Therefore, as the housing member is seen from the side view, the thickness of the housing member increases.

However, in terms of transportation of the projection display apparatus, it is preferable that the thickness of the housing member be small.

### SUMMARY OF THE INVENTION

A projection display apparatus (projection display apparatus 100) according to a first feature includes a housing member (housing member 200) that houses a light source (light source 10), an imager (DMD 70) that modulates light emitted from the light source, and a projection unit (projection unit 110) that projects light emitted from the imager onto a projection plane. The projection unit has a concave mirror (concave mirror 112) that reflects the light emitted from the imager to the projection plane side. The housing member pivotally supports the concave mirror along a circumference of a virtual circle formed by a virtual extension line of the concave mirror.

A projection display apparatus (projection display apparatus 100) according to a second feature includes a housing member (housing member 200) that houses a light source (light source 10), an imager (DMD 70) that modulates light emitted from the light source, and a projection unit (projection unit 110) that projects light emitted from the imager onto a projection plane. The projection unit has a concave mirror (concave mirror 112) that reflects the light emitted from the imager to the projection plane side. The housing member covers at least a side face of the concave mirror and pivotally supports the concave mirror.

In the second feature, the projection unit has a projection lens group that expands the light emitted from the imager, in addition to the concave mirror. The housing member includes a first housing member that houses the light source, the imager, and the projection lens group and a second housing member that houses the concave mirror. The second housing member is pivotally supported by the first housing member along with the concave mirror. A side face of the concave mirror is covered with at least any one of the first and second housing members.

A projection display apparatus (projection display apparatus 100) according to a third feature includes a housing member (housing member 200) that houses a light source (light source 10), an imager (DMD 70) that modulates light emitted from the light source, and a projection unit (projection unit 110) that projects light emitted from the imager onto a projection plane. The projection unit has a concave mirror (concave mirror 112) that reflects the light emitted from the imager to the projection plane side. The housing member covers at least a side face of the concave mirror and slidingly supports the concave mirror along a direction perpendicular to an optical axis of the projection unit as the housing member is seen from a side view.

### BRIEF DESCRIPTION OF THE DRAWINGS

FIG. 1 is a diagram illustrating a projection display apparatus 100 according to a first embodiment.

FIG. 2 is a diagram illustrating the projection display apparatus 100 according to the first embodiment.

FIG. 3 is a diagram illustrating pivoting of a concave mirror 112 according to the first embodiment.

FIG. 4 is a diagram illustrating pivoting of the concave mirror 112 according to a first modification.

FIG. 5 is a diagram illustrating pivoting of the concave mirror 112 according to a second embodiment.

FIG. 6 is a diagram illustrating sliding of the concave mirror 112 according to a third embodiment.

FIG. 7 is a diagram illustrating a first storage configuration according to a fourth embodiment.

FIG. 8 is a diagram illustrating the first storage configuration according to the fourth embodiment.

### MODES FOR CARRYING OUT THE INVENTION

Hereinafter, a projection display apparatus according to embodiments of the present invention is described with reference to drawings. Note that in the descriptions of the drawing, identical or similar symbols are assigned to identical or similar portions.

It will be appreciated that the drawings are schematically illustrated and the ratio and the like of each dimension are different from the real ones. Therefore, the specific dimensions, etc., should be determined in consideration of the following explanations. Of course, among the drawings, the dimensional relationship and the ratio are different.

### Overview of First Embodiment

A projection display apparatus according to the first embodiment includes a housing member that houses a light source, an imager that modulates light emitted from the light source, and a projection unit that projects light emitted from the imager onto the projection plane. The projection unit has a concave mirror that reflects the light emitted from the imager, to the projection plane side. The housing member pivotally supports the concave mirror along the circumference of the virtual circle formed by a virtual extension line of the concave mirror.

According to the first embodiment, the housing member pivotally supports the concave mirror along the circumference of the virtual circle formed by the virtual extension line of the concave mirror. Therefore, it is possible to reduce the thickness of the housing member, when the concave mirror is housed, by pivoting the concave mirror along the circumference of the virtual circle. In addition, since the concave mirror is pivoted along the circumference of the virtual circle, it is possible to reduce the effect of a positional deviation caused by pivoting of the concave mirror. Specifically, even when the concave mirror is slightly deviated from a fixed position where the concave mirror is to be fixed during the use of the concave mirror, the position (such as an inclination) of the reflection surface of the concave mirror is not significantly deviated. Therefore, it is possible to suppress distortion of the image projected onto the projection plane when the concave mirror is used.

### Details of First Embodiment

### (Simplified Configuration of Projection Display Apparatus)

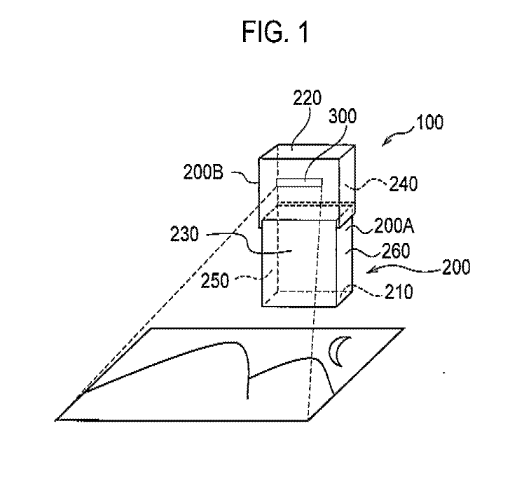

Hereinafter, a simplified configuration of the projection display apparatus according to the first embodiment is described with reference to drawings. FIG. 1 is a diagram illustrating a projection display apparatus 100 (floor projection) according to the first embodiment.

As illustrated in FIG. 1, the projection display apparatus 100 has a housing member 200 and projects an image onto a projection plane (not shown). A transmission area 300 through which light emitted from a projection unit 110 described later transmits is installed in the housing member 200.

Here, the projection display apparatus 100 placed on a horizontal plane such as a floor or a desk top, projects image light onto the projection plane installed on a horizontal plane such as a floor or a desk top.

According to the first embodiment, the housing member 200 includes a first housing member 200A and a second housing member 200B. The housing member 200 includes a bottom plate 210, a top plate 220, a front plate 230, a rear plate 240, a first side plate 250, and a second side plate 260. The housing member 200 has an almost rectangular parallelepiped shape.

The bottom plate 210 faces an installation surface of the housing member 200 and includes a first housing member 200A. The top plate 220 is installed on the opposite side of the bottom plate 210, and is formed by a part of the second housing member 200B. The front plate 230 has a transmission area 300 and includes a part of the second housing member 200B and the first housing member 200A. In addition, the transmission area 300 is provided in the second housing member 200B. The rear plate 240 is provided on the opposite side of the front plate 230 and includes a part of the second housing member 200B and the first housing member 200A. The first and second side plates 250 and 260 are the rest of the side plates and include a part of the second housing member 200B and the first housing member 200A.

Note that the projection display apparatus 100 has a size of a PET bottle having a volume of 200 ml to 2 I. For example, if the volume of the projection display apparatus 100 is about 900 ml then its weight is about 800 g. The size of the image displayed by the projection display apparatus 100 is about 20 inches, for example. It should be noted that the distance between the projection display apparatus 100 and the projection plane is very close.

### (Optical Configuration of Projection Display Apparatus)

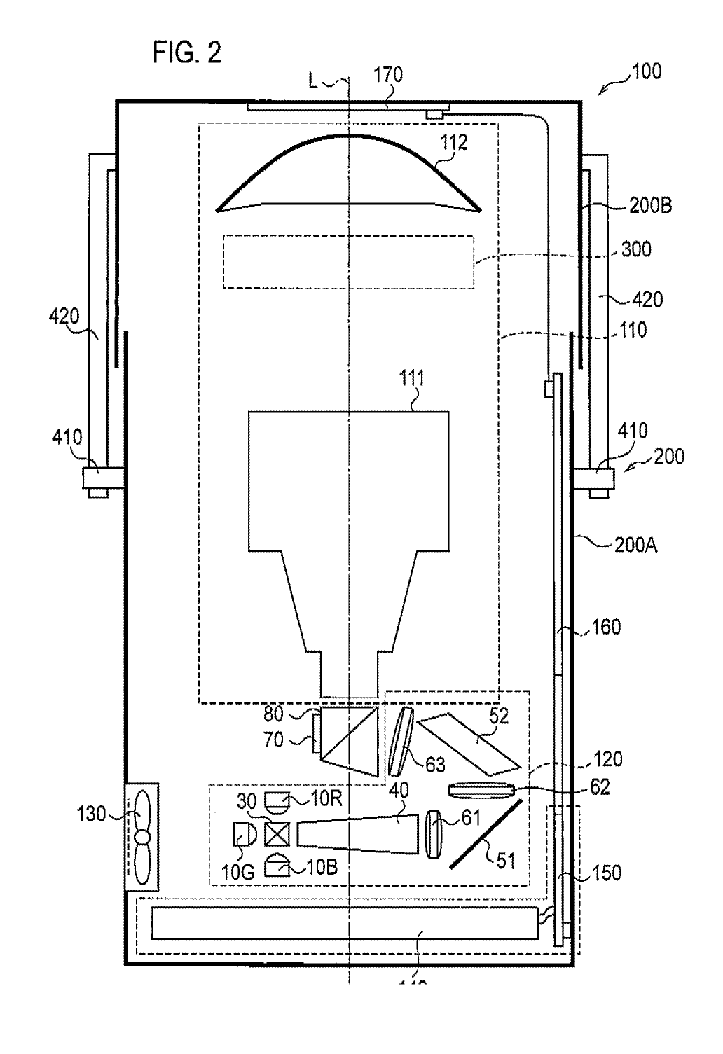

Hereinafter, an optical configuration of the projection display apparatus according to the first embodiment is described with reference to drawings. FIG. 2 is a diagram mainly illustrating the optical configuration of the projection display apparatus 100 according to the first embodiment.

As illustrated in FIG. 2, the projection display apparatus 100 includes a projection unit 110, an illumination unit 120, a cooling fan 130, a battery 140, a power board 150, a main control board 160, and a manipulation board 170. In addition, the projection display apparatus 100 has a DMD 70 and a reflection prism 80.

The projection unit 110 projects the color component light (image light) that has emitted from the DMD 70 onto the projection plane. Specifically, the projection unit 110 has a projection lens group 111 and a concave mirror 112.

The projection lens group 111 outputs the color component light (image light) that is output from the DMD 70, to the concave mirror 112 side. The projection lens group 111 includes a lens which has an almost circular shape that is around the optical axis L of the projection unit 110 and another lens which has a part of an almost circular shape (for example, a semicircular shape in the lower half) that is around the optical axis L of the projection unit 110

It should be noted that the diameter of the lens included in the projection lens group 111 is larger as it is located nearer the concave mirror 112.

The concave mirror 112 reflects the color component light (image light) that has emitted from the projection lens group 111. The concave mirror 112 focusing the image light, and then scatters the image light over a wide angle. For example, the concave mirror 112 is an aspherical mirror including a concave surface on the side of the projection lens group 111. Here, the concave mirror 112 has a part of an almost circular shape (for example, a semicircular shape in the lower half) that is around the optical axis L of the projection unit 110.

The image light focused onto the concave mirror 112 transmits through the transmission area 300 provided in the housing member 200. The transmission area 300 provided in the housing member 200 preferably is provided in the vicinity of the position where the image light is focused by the concave mirror 112. The transmission area 300 is preferably formed of protection glass.

The illumination unit 120 includes a light source 10, a dichroic prism 30, a rod integrator 40, a mirror 51, a mirror 52, a lens 61, a lens 62, and a lens 63.

The light source 10 respectively outputs a plurality of color component light beams. Further, a heat sink to dissipate the heat generated in the light source 10 can also be annexed in the light source 10. For example, the light source 10 includes a light source 10R, a light source 10G, and a light source 10B.

The light source 10R is a light source from which red component light R emerges, and is a red Light Emitting Diode (LED) or a red Laser Diode (LD), for example. A heat sink made from a member having excellent heat dissipation properties such as a metal can be annexed in the light source 10R.

The light source 10G is a light source from which green component light G emerges, and is a green LED or a green LD, for example. A heat sink made from a member having excellent heat dissipation properties such as a metal can be annexed in the light source 10G.

The light source 10B is a light source from which blue component light B emerges, and is a blue LED or a blue LD, for example. A heat sink made from a member having excellent heat dissipation properties such as a metal can be annexed in the light source 10B.

The dichroic prism 30 combines the red component light R emitted from the light source 10R, the green component light G emitted from the light source 10G, and the blue component light B emitted from the light source 10B.

The rod integrator 40 has a light incidence face, a light emergence face, and a light reflection side face extending from the outer periphery of the light incidence face to the outer periphery of the light emergence face. The rod integrator 40 collimates the color component light that has emitted from the dichroic prism 30. More particularly, the rod integrator 40 collimates the color component light by reflecting the color component light at the light reflection side face. In addition, the rod integrator 40 may be a solid rod made of glass and the like or a hollow rod having an inner face having a mirror surface.

For example, according to the first embodiment, the rod integrator 40 has a tapered shape such that the area of the cross-section perpendicular to the light propagation direction increases toward the propagation direction of the light emitted from the light source 10. However, the embodiment is not limited thereto. The rod integrator 40 may have an inversely tapered shape such that the area of the cross-section perpendicular to the light propagation direction decreases toward the propagation direction of the light emitted from the light source 10.

The mirrors 51 and 52 are reflection mirrors for bending the optical path of the light in order to guide the light that has emitted from the rod integrator 40 into the DMD 70.

The lenses 61, 62, and 63 are relay lenses for approximately imaging the color component light onto the DMD 70 while suppressing expansion of the color component light that has emitted from the light source 10.

The cooling fan 130 communicates with an external side of the housing member 200 to discharge the heat inside the housing member 200. Alternatively, the cooling fan 130 sends the air outside the housing member 200 into the inner side of the housing member 200. For example, the cooling fan 130 is positioned in the vicinity of the light source 10 and cools the light source 10.

The battery 140 stores electric power to be supplied to the projection display apparatus 100. In addition, the battery 140 is preferably arranged at the side nearest the bottom plate 210 in order to stabilize the gravity center of the housing member 200.

The power board 150 is connected to the battery 140 and has a power conversion circuit for converting AC power into DC power.

The main control board 160 has a main control circuit for controlling the operation of the projection display apparatus 100.

The manipulation board 170 is connected to a manipulation unit (such as a button) provided in the projection display apparatus 100 and transmits the manipulation signal input from the manipulation unit to the main control board 160 (main control circuit).

The DMD 70 includes a plurality of micromirrors, and each of micromirrors is respectively movable. Each micromirror is basically equivalent to one pixel. The DMD 70 switches whether or not the color component light is reflected to guide the color component light as effective light into the projection unit 110 side by changing an angle of each micromirror.

The reflection prism 80 transmits the light emitted from the illumination unit 120, to the DIVED 70 side. Meanwhile, the reflection prism 80 reflects the light emitted from the DMD 70, to the projection unit 110 side.

According to the first embodiment, the first housing member 200A houses the light source 10, the dichroic prism 30, the rod integrator 40, the DMD 70, the reflection prism 80, the projection lens group 111, and the like.

Meanwhile, the second housing member 200 B houses the concave mirror 112. In addition, the second housing member 200B preferably covers at least the side face of the concave mirror 112. In addition, the second housing member 200B may cover the front, rear, and top faces of the concave mirror 112.

Here, the first housing member 200A is provided with a pivot axis 410, and the second housing member 200B is provided with a connecting arm 420. The connecting arm 420 is fixed to the pivot axis 410.

In this configuration, the first housing member 200A pivotally supports the second housing member 200B around the pivot axis 410.

In addition, the concave mirror 112 is fixed to the second housing member 200B and is pivoted around the pivot axis 410 as the second housing member 200B is pivoted. That is, the first housing member 200A makes the concave mirror 112 be pivoted around the pivot axis 410.

Of course, the shapes of the first and second housing members 200A and 200B are defined such that the first housing member 200A and the second housing member 200B are not interfered with each other as the second housing member 200E is pivoted. For example, the first and second side plates 250 and 260 formed by a part of the second housing member 200E are provided outside the first and second side plates 250 and 260 formed by a part of the first housing member 200A. Alternatively, the first and second side plates 250 and 260 formed by a part of the second housing member 200B may be provided inside the first and second side plates 250 and 260 formed by a part of the first housing member 200A.

### (Pivoting of Concave Mirror)

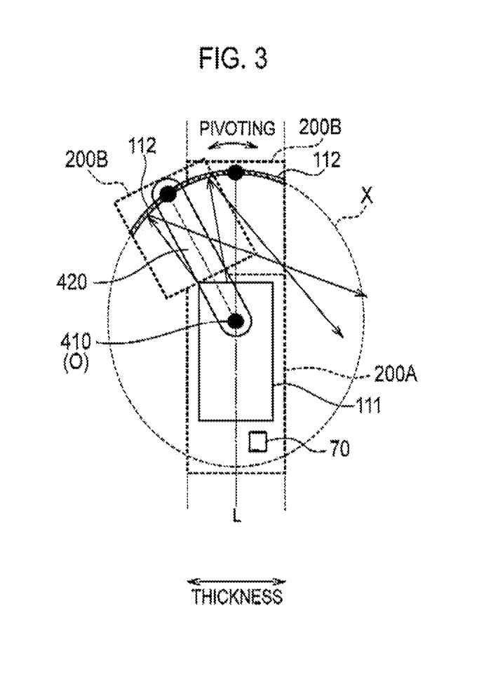

Hereinafter, pivoting of the concave mirror according to the first embodiment will be described with reference to the accompanying drawings. FIG. 3 is a diagram illustrating pivoting of the concave mirror 112 according to the first embodiment. FIG. 3 is a diagram illustrating the projection display apparatus 100 (housing member 200) as seen from the side view.

As illustrated in FIG. 3, the concave mirror 112 is provided on the opposite side of the DMD 70 with respect to the optical axis of the projection unit 110 (projection lens group 111) as the projection display apparatus 100 (housing member 200) is seen from the side view. In addition, it is noted that the concave mirror 112 may be provided on the opposite side of the DMD 70 when the concave mirror 112 is used. In other words, it is not necessary to provide the concave mirror 112 on the opposite side of the DMD 70 when the concave mirror 112 is housed.

Here, the concave mirror 112 is pivoted along the circumference of the virtual circle X formed by the virtual extension line of the concave mirror 112. That is, the pivot axis 410 is arranged in the approximate center O of the virtual circle X. In addition, the connecting arm 420 constitutes a pivot radius of the concave mirror 112.

In this manner, the housing member 200 (first housing member 200A) pivotally supports the concave mirror 112 along the circumference of the virtual circle X formed by the virtual extension line of the concave mirror 112.

In addition, the virtual circle formed by the virtual extension line of the concave mirror 112 is not necessary to be a true circle. That is, the virtual circle may be elliptical. In addition, when the virtual circle is elliptical, the connecting arm 420 may slidingly support the concave mirror 112 along the connecting arm 420.

A locking mechanism for locking the concave mirror 112 may be provided in the use position of the concave mirror 112. The locking mechanism is, for example, a stopper (such as a gear) for restricting pivoting of the pivot axis 410.

### (Operation and Effect)

According to the first embodiment, the housing member 200 (first housing member 200A) pivotally supports the concave mirror 112 along the circumference of the virtual circle formed by the virtual extension line of the concave mirror 112. Therefore, it is possible to reduce the thickness of the housing member 200, when the concave mirror 112 is housed, by pivoting the concave mirror 112 along the circumference of the virtual circle. In addition, it is possible to reduce the effect of a positional deviation caused by pivoting of the concave mirror 112 because the concave mirror 112 is pivoted along the circumference of the virtual circle. Specifically, even when the concave mirror 112 is slightly deviated from the fixing position where the concave mirror 112 is to be fixed when the concave mirror 112 is used, the position of the reflection surface of the concave mirror is not significantly deviated. Therefore, it is possible to suppress distortion of images projected onto the projection plane when the concave mirror 112 is used.

### [First Modification]

Hereinafter, a first modification of the first embodiment is explained. Mainly the differences from the first embodiment are described, below.

Specifically, according to the first embodiment, the pivot axis 410 is arranged in the approximate center of the virtual circle X. In comparison, according to the first modification, the pivot axis 410 is arranged in the connecting portion between the first and second housing members 200A and 200B.

### (Pivoting of Concave Mirror)

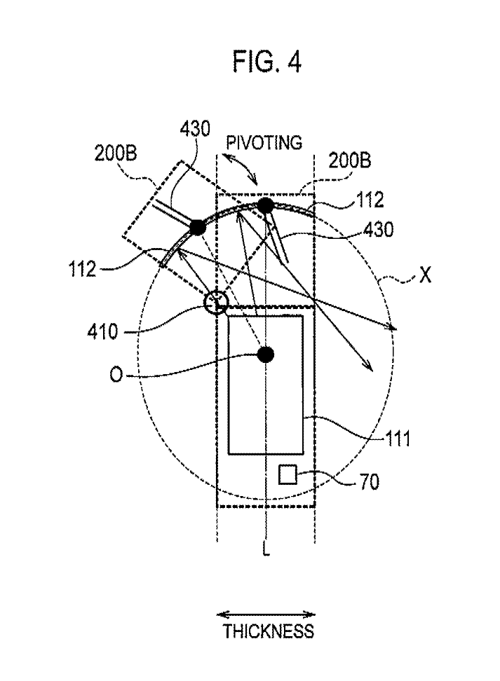

Hereinafter, the pivoting of the concave mirror according to the first modification will be described with reference to the accompanying drawings. FIG. 4 is a diagram illustrating pivoting of the concave mirror 112 according to the first embodiment. FIG. 4 is a diagram illustrating the projection display apparatus 100 (housing member 200) as seen from the side view.

As illustrated in FIG. 4, the pivot axis 410 is arranged in the connecting portion between the first and second housing members 200A and 200B in the rear plate 240 side.

According to the first modification, since the position of the pivot axis 410 is different from the position of the center O of the virtual circle X, the concave mirror 112 is not pivoted along the circumference of the virtual circle X if the concave mirror 112 is simply pivoted around the pivot axis 410.

According to the first modification, in order to make the concave mirror 112 be pivoted along the circumference of the virtual circle X, the second housing member 200B has a slide mechanism 430 for slidingly supporting the concave mirror 112. Specifically, since the concave mirror 112 slides in synchronization with pivoting of the concave mirror 112, the concave mirror 112 is pivoted along the circumference of the virtual circle X.

### Overview of Second Embodiment

A projection display apparatus according to the second embodiment includes a housing member that houses a light source, an imager that modulates light emitted from the light source, and a projection unit that projects light emitted from the imager, onto the projection plane. The projection unit has a concave mirror that reflects the light emitted from the imager to the projection plane side. The concave mirror is arranged on the opposite side of the imager with respect to the optical axis of the projection unit as the housing member is seen from the side view. The housing member covers at least the side face of the concave mirror and pivotally supports the concave mirror.

According to the second embodiment, the housing member covers at least the side face of the concave mirror and pivotally supports the concave mirror. Therefore, it is possible to reduce the thickness of the housing member, when the concave mirror is housed, by pivoting the concave mirror. In addition, since the side face of the concave mirror is covered with at least the housing member, it is possible to suppress a user from making contact with the concave mirror. As a result, it is possible to suppress a positional deviation of the concave mirror when the concave mirror is used.

Mainly the differences from the first embodiment are described, below. Therefore, repeated description will be omitted.

### Details of Second Embodiment

### (Pivoting of Concave Mirror)

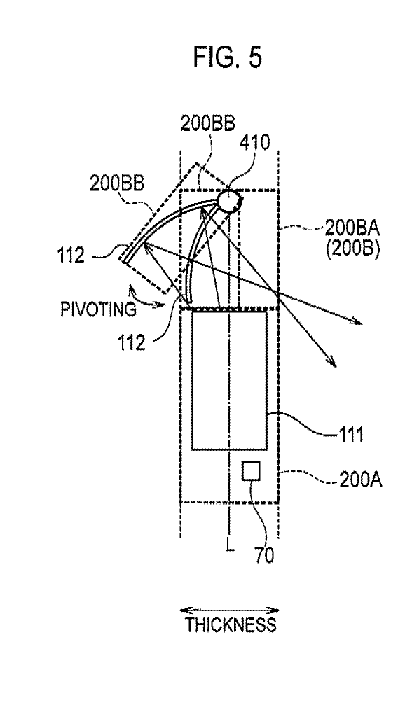

Hereinafter, pivoting of the concave mirror according to the second embodiment will be described with reference to the accompanying drawings. FIG. 5 is a diagram illustrating pivoting of the concave mirror 112 according to the second embodiment. FIG. 5 is a diagram illustrating the projection display apparatus 100 (housing member 200) as seen from the side view.

As illustrated in FIG. 5, the second housing member 200B includes a second housing member 200BA and a second housing member 200BB. The second housing member 200BA is provided in the front plate 230 side and has the transmission area 300 described above. The second housing member 200BB is provided in the rear plate 240 side and houses the concave mirror 112 described above.

According to the second embodiment, the second housing member 20013B covers at least the side face of the concave mirror 112. In addition, the second housing member 200BB may cover the rear, top, and bottom faces of the concave mirror 112. The bottom face is the face provided in the bottom plate 210 side out of the faces of the second housing member 200BB.

The pivot axis 410 is arranged in the connecting portion between the second housing member 200BA and the second housing member 200BB in the top plate 220 side. In addition, a locking mechanism for locking the concave mirror 112 may be provided in the use position of the concave mirror 112. The locking mechanism is, for example, a stopper (such as a gear) for restricting pivoting of the pivot axis 410.

### (Operation and Effect)

According to the second embodiment, the housing member 200 covers at least the side face of the concave mirror 112 and pivotally supports the concave mirror 112. Therefore, it is possible to reduce the thickness of the housing member 20, when the concave mirror 112 is housed, by pivoting the concave mirror 112. In addition, since the side face of the concave mirror is covered with at least the housing member 200 (second housing member 200BB), it is possible to suppress a user from making contact with the concave mirror 112. As a result, it is possible to suppress a positional deviation of the concave mirror 112 when the concave mirror 112 is used.

### Overview of Third Embodiment

A projection display apparatus according to the third embodiment includes a housing member that houses a light source, an imager that modulates light emitted from the light source, and a projection unit that projects light emitted from the imager onto the projection plane. The projection unit has a concave mirror that reflects the light emitted from the imager, to the projection plane side. The concave mirror is arranged on the opposite side of the imager with respect to the optical axis of the projection unit as the housing member is seen from the side view. The housing member covers at least the side face of the concave mirror and slidingly supports the concave mirror along the direction perpendicular to the optical axis of the projection unit as the housing member is seen from the side view.

According to the third embodiment, the housing member covers at least the side face of the concave mirror and slidingly supports the concave mirror along the direction perpendicular to the optical axis of the projection unit as the housing member is seen from the side view. Therefore, it is possible to reduce the thickness of the housing member, when the concave mirror is housed, by sliding the concave mirror. In addition, since the side face of the concave mirror is covered with at least the housing member, it is possible to suppress a user from making contact with the concave mirror. As a result, it is possible to suppress a positional deviation of the concave mirror when the concave mirror is used.

Mainly the differences from the first embodiment are described, below. Therefore, repeated description will be omitted.

### Details of Third Embodiment

### (Sliding of Concave Mirror)

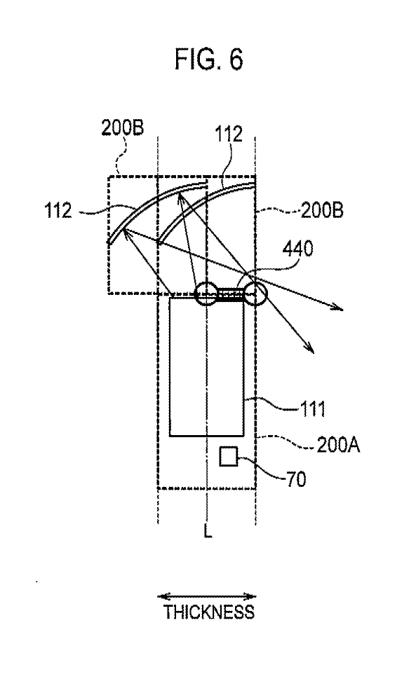

Hereinafter, sliding of the concave mirror according to the third embodiment will be described with reference to the accompanying drawings. FIG. 6 is a diagram illustrating sliding of the concave mirror 112 according to the second embodiment. FIG. 6 is a diagram illustrating the projection display apparatus 100 (housing member 200) as seen from the side view.

As illustrated in FIG. 6, the first housing member 200A includes a slide mechanism 440 that slidingly supports the second housing member 200B.

The slide mechanism 440 slidingly supports the concave mirror 112 along the direction perpendicular to the optical axis of the projection unit 110 as the projection display apparatus 100 (housing member 200) is seen from the side view. In addition, a locking mechanism for locking the concave mirror 112 may be provided in the use position of the concave mirror 112. The locking mechanism is, for example, a stopper for restricting sliding of the second housing member 2008.

According to the second embodiment, the second housing member 200B covers at least the side face of the concave mirror 112. In addition, the second housing member 200B may cover the front, rear, and top faces of the concave mirror 112.

### (Operation and Effect)

According to the third embodiment, the housing member 200 covers at least the side face of the concave mirror 112 and slidingly supports the concave mirror 112 along the direction perpendicular to the optical axis of the projection unit 110 as the housing member 200 is seen from the side view. Therefore, it is possible to reduce the thickness of the housing member 200, when the concave mirror 112 is housed, by sliding the concave mirror 112. In addition, since the side face of the concave mirror 112 is covered with at least the housing member 200, it is possible to suppress a user from making contact with the concave mirror 112. As a result, it is possible to suppress a positional deviation of the concave mirror 112 when the concave mirror 112 is used.

### Fourth Embodiment

Hereinafter, a fourth embodiment will be explained. Mainly the differences from the first embodiment are described, below.

Specifically, according to the fourth embodiment, pivoting of the concave mirror 112 and sliding of the concave mirror 112 are combined. Here, as a configuration for storing the concave mirror 112, two configurations will be exemplarily illustrated.

According to the fourth embodiment, the projection display apparatus 100 includes a pivot axis 410, a connecting arm 420, and a slide mechanism 450.

The pivot axis 410 is an axis for pivoting the second housing member 200B and is provided in the first housing member 200A. The connecting arm 420 is a member for connecting the first housing member 200A (pivot axis 410) and the second housing member 200B. The slide mechanism 450 is a mechanism for sliding the second housing member 200E along the connecting arm 420.

### (First Storage Configuration)

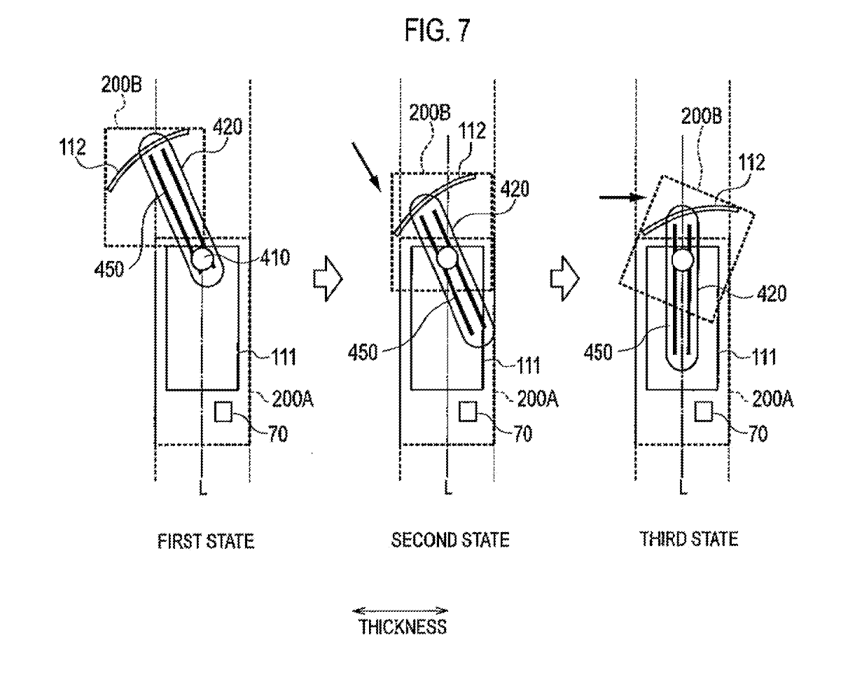

Hereinafter, the first storage configuration will be described with reference to FIG. 7. FIG. 7 is a diagram illustrating the first storage configuration.

The first state shows a state of the housing member 200 when the concave mirror 112 is used. The third state shows a state of the housing member 200 when the concave mirror 112 is housed. The second state shows a state of the housing member 200 between the first state and the third state.

As illustrated in FIG. 7, when the state transitions from the first state to the second state, the second housing member 200B slides along the connecting arm 420 using the slide mechanism 450. When the state transitions from the second state to the third state, the second housing member 200B is pivoted around the pivot axis 410. As a result, it is possible to reduce the thickness of the housing member 200 when the concave mirror 112 is housed.

### (Second Storage Configuration)

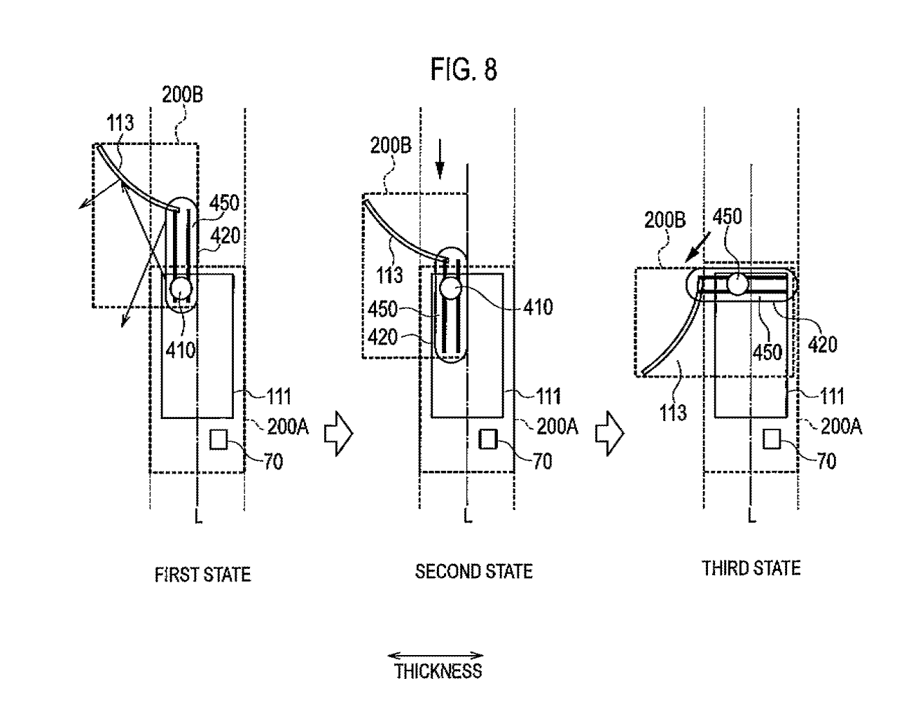

Hereinafter, a second storage configuration will be described with reference to FIG. 8. FIG. 8 is a diagram illustrating the second storage configuration. Here, in the second configuration example, a convex mirror 113 is used instead of the concave mirror 112.

The first state shows a state of the housing member 200 when the concave mirror 112 is used. The third state shows a state of the housing member 200 when the concave mirror 112 is housed. The second state shows a state of the housing member 200 between the first state and the third state.

As illustrated in FIG. 8, when the state transitions from the first state to the second state, the second housing member 200B slides along the connecting arm 420 using the slide mechanism 450. When the state transitions from the second state to the third state, the second housing member 200B is pivoted around the pivot axis 410. As a result, it is possible to reduce the thickness of the housing member 200 when the concave mirror 112 is housed.

### Other Embodiments

The present invention is explained through the above embodiments, but it must not be assumed that this invention is limited by the statements and drawings constituting a part of this disclosure. From this disclosure, various alternative embodiments, examples, and operational technologies will become apparent to those skilled in the art.

In the embodiments, description has been made for a case where the side face of the concave mirror 112 is covered with the second housing member 200B. However, the embodiment is not limited thereto. Specifically, the side face of the concave mirror 112 may be covered with the first housing member 200A. In this case, the side face of the concave mirror 112 may not necessarily be covered with the second housing member 200B.

In the embodiments, as the imager, the Digital Micromirror Device (DMD) has been provided merely as an example. The imager may be a reflective liquid crystal panel, and may also be a transparent liquid crystal panel.

In the embodiments, as the light source, the LED or the LD has been provided merely as an example. However, the light source may be an Electro Luminescence (EL).

1. A projection display apparatus including a housing member that houses a light source, an imager that modulates light emitted from the light source, and a projection unit that projects light emitted from the imager onto a projection plane, wherein
the projection unit has a concave mirror that reflects the light emitted from the imager to the projection plane side, and
the housing member pivotally supports the concave mirror along a circumference of a virtual circle formed by a virtual extension line of the concave mirror.

2. A projection display apparatus including a housing member that houses a light source, an imager that modulates light emitted from the light source, and a projection unit that projects light emitted from the imager, onto a projection plane, wherein
the projection unit has a concave mirror that reflects the light emitted from the imager to the projection plane side, and
the housing member covers at least a side face of the concave mirror and pivotally supports the concave mirror.

3. The projection display apparatus according to claim 2, wherein
the projection unit has a projection lens group that expands the light emitted from the imager, in addition to the concave mirror,
the housing member includes a first housing member that houses the light source, the imager, and the projection lens group and a second housing member that houses the concave mirror,
the second housing member is pivotally supported by the first housing member along with the concave mirror, and
a side face of the concave mirror is covered with at least any one of the first and second housing members.

4. A projection display apparatus including a housing member that houses a light source, an imager that modulates light emitted from the light source, and a projection unit that projects light emitted from the imager, onto a projection plane, wherein
the projection unit has a concave mirror that reflects the light emitted from the imager to the projection plane side, and
the housing member covers at least a side face of the concave mirror and slidingly supports the concave mirror along a direction perpendicular to an optical axis of the projection unit as the housing member is seen from a side view.
